(19) United States
(12) Patent Application Publication
(10) Pub. No.: US 2021/0377454 A1
(43) Pub. Date: Dec. 2, 2021

(54) CAPTURING METHOD AND DEVICE

(71) Applicants: Beijing Xiaomi Mobile Software Co., Ltd. Nanjing Branch, Nanjing (CN); Beijing Xiaomi Mobile Software Co., Ltd., Beijing (CN)

(72) Inventors: Xiaojun WU, Beijing (CN); Daming XING, Beijing (CN)

(73) Assignees: Beijing Xiaomi Mobile Software Co., Ltd. Nanjing Branch; Beijing Xiaomi Mobile Software Co., Ltd.

(21) Appl. No.: 17/200,104

(22) Filed: Mar. 12, 2021

Related U.S. Application Data
(63) Continuation of application No. PCT/CN2020/093531, filed on May 29, 2020.

(51) Int. Cl. H04N 5/232; G06K 9/00

(52) U.S. Cl. CPC H04N 5/232939; G06K 9/00671; H04N 5/232935

(57) ABSTRACT

A capturing method for an electronic device, includes: obtaining an image captured during a capturing process, obtaining a target pop-up comment matching image information of the image, and displaying the image and the target pop-up comment.

### CROSS REFERENCE TO RELATED APPLICATIONS

This application is a continuation application of International Application No. PCT/CN2020/093531, filed on May 29, 2020, the content of which is incorporated herein by reference in its entirety.

### TECHNICAL FIELD

The present disclosure relates to the field of computer communication, and in particular, to a capturing method and device.

### BACKGROUND

An electronic device may be installed with a camera, and thus have a capturing function. Conventionally, after starting the camera, the electronic device displays an image captured by the camera on a screen, and performs capturing after receiving a capturing instruction input by a user, so as to obtain a photograph or a video.

### SUMMARY

According to a first aspect of embodiments of the present disclosure, a capturing method for an electronic device, includes: obtaining an image captured during a capturing process; obtaining a target pop-up comment matching image information of the image; and displaying the image and the target pop-up comment.

According to a second aspect of embodiments of the present disclosure, a capturing method for a server, includes: obtaining image information of an image captured by an electronic device; determining a target pop-up comment matching the image information; and sending the target pop-up comment to the electronic device.

According to a third aspect of embodiments of the present disclosure, an electronic device includes: a processor; and a memory storing instructions executable by the processor, wherein the processor is configured to: obtain an image captured during a capturing process; obtain a target pop-up comment matching the image information of the image; and display the image and the target pop-up comment

According to a fourth aspect of embodiments of the present disclosure, a server includes: a processor; and a memory storing instructions executable by the processor, wherein the processor is configured to: obtain image information of an image captured by an electronic device; determine a target pop-up comment matching the image information; and send the target pop-up comment to the electronic device.

According to a fifth aspect of embodiments of the present disclosure, a non-transitory computer-readable storage medium has stored thereon instructions that, when executed by a processor of an electronic device, cause the electronic device to perform the method according to the first aspect.

According to a sixth aspect of embodiments of the present disclosure, a non-transitory computer-readable storage medium has stored thereon instructions that, when executed by a processor of a server, cause the server to perform the method according to the second aspect.

The technical solutions provided by the embodiments of the present disclosure may include the following beneficial effects.

In the embodiments of the present disclosure, the electronic device obtains the image captured during the capturing process, obtains a target pop-up comment matching image information of the image, and displays the image and the target pop-up comment, thereby increasing the interest and interaction at the capturing stage, and improving user experience.

It shall be appreciated that the above general description and the following detailed description are merely illustrative and explanatory and do not limit the present disclosure.

### BRIEF DESCRIPTION OF DRAWINGS

The accompanying drawings, which are incorporated in and constitute a part of this specification, illustrate embodiments consistent with the present disclosure and, together with the description, serve to explain the principles of the disclosure.

FIG. 1 is a flowchart of a capturing method according to an exemplary embodiment.

FIG. 2 is an image displayed on a screen according to an exemplary embodiment.

FIG. 3 is a flowchart of a capturing method according to an exemplary embodiment.

FIG. 4 is a block diagram of a capturing apparatus according to an exemplary embodiment.

FIG. 5 is a block diagram of a capturing apparatus according to an exemplary embodiment.

FIG. 6 is a block diagram of an electronic device according to an exemplary embodiment.

FIG. 7 is a block diagram of a server according to an exemplary embodiment.

### DETAILED DESCRIPTION OF THE EMBODIMENTS

Detailed description will be made here to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

Terms used in the present disclosure are for the purpose of describing exemplary embodiments and are not intended to limit the present disclosure. For example, although the terms “first”, “second”, “third” and the like may be used herein to describe various information, the information should not be limited by these terms. These terms are only used to distinguish various information. For example, without departing from the scope of the present disclosure, first information may be referred as to second information; and similarly, second information may also be referred to as first information.

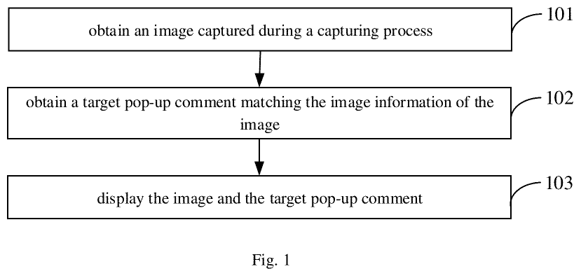

FIG. 1 is a flowchart of a capturing method according to an exemplary embodiment. The method is applicable to an electronic device, and includes the following steps.

In step 101, an image captured during a capturing process is obtained.

In embodiments of the present disclosure, the electronic device is installed with a screen and a camera, and has a display function and a capturing function. The method is applicable to a variety of suitable electronic devices, such as mobile phones, tablets, cameras, cameras, and the like.

For an electronic device such as a mobile phone and a tablet, a camera application is installed on the electronic device. After the camera application is started, a camera thereon is enabled and used for acquiring an image. For an electronic device such as a camera and a webcam, the electronic device is dedicated to image capturing. After the electronic device is started, a camera thereon is enabled and used for acquiring an image.

The electronic device may obtain the image captured by the camera in an image capturing process, or the electronic device may obtain the image captured by the camera in a video capturing process.

The obtained image may be a preview image in the capturing process, or may be an image obtained after a user inputs a capturing instruction.

In step 102, a target pop-up comment matching image information of the image is obtained.

In an embodiment, after obtaining the image, the electronic device further obtains image information of the image. Multiple types of image information are provided, for example, the image information may include at least one of: image data, capturing scene information or image classification information. The pop-up may be a website interaction mechanism, which indicates that a user may make a comment on works such as a video or an image. The comment may fly through the works on the screen as flow subtitles and may be seen by another user.

Multiple types of image data may be provided, for example, the image data may include at least one of: image per se, image color data, or image brightness data, or the like.

The capturing scene information may indicate a specific capturing scene of the image.

The image classification information may indicate classification of an image. Multiple types of image classification information are provided, for example, scene type information, content category information, etc. The scene type information indicates the type of the capturing scene corresponding to the image, and the content type information indicates the type of the capturing content corresponding to the image.

Multiple types of scene type information may be provided, for example, an indoor scene, an outdoor scene, a food scene, a landscape scene, etc.

There may be multiple classification criteria for the content category information, for example, species of an capturing object, attribute information of the capturing object, appearance of the capturing object, and the like. In an embodiment, the capturing object may be divided according to the species, and the obtained content category information may include a person, an animal, an item, a food, etc. In another embodiment, the attribute information of the capturing object may include gender, age, height, weight, appearance, etc., and the capturing object is divided according to the attribute information of the capturing object, and the content category information may include men, women, children, adults, elderly, good looking, bad looking, etc. In another embodiment, the capturing object is divided according to the appearance, and the obtained content category information may include a circle, a square, a triangle, a rule graph, an irregular graph, etc.

The electronic device may obtain image information by means of image recognition, network model, etc.

In an embodiment, the electronic device may obtain image classification information of an image using one of the following methods. In a first method, in a case where the image classification information includes the content classification information, the content classification information of the image is determined according to the content of the image.

In a second method, in a case where the image classification information includes scene classification information, the capturing scene information of the image is determined according to the content of the image, and the scene classification information corresponding to the capturing scene information is determined. For example, during the process of capturing a food, the electronic device determines, according to the contents of the image, that the food is included in the image, and determines the food scene corresponding to the food.

In an embodiment, a pop-up comment corresponding to different image information is different.

The electronic device may obtain the target pop-up comment matching the image information in a variety of ways. For example, after obtaining the image information, the electronic device may send the image information to a server, such that the server obtains a target pop-up comment matching the image information, and the electronic device receives the target pop-up comment from the server.

When the image information includes the image per se, the electronic device may send the image to the server, the server may directly determine a target pop-up comment matching the image, or the server may determine at least one of image color information, image brightness information, capturing scene information or image classification information of the image, and determine a target pop-up comment which matches such information.

When the image information includes one or more of image color information, image brightness information, capturing scene information, and image classification information, the electronic device sends such information to the server, and the server determines a target pop-up comment which matches such information.

In the above embodiment, the operation of determining the target pop-up comment matching the image information is performed by the server, reducing operations of the electronic device, and the electronic device does not need to store the pop-up comment, reducing the storage load of the electronic device.

In another embodiment, the electronic device locally stores a pop-up comment library, and the electronic device may obtain the target pop-up comment matching the image information from the locally stored pop-up comment library.

In some embodiments, different pop-up comment libraries corresponding to different image information are different. For example, a pop-up comment library about food is established for food scenes, and a pop-up comment library about landscape is established for landscape scenes.

The storage space of the electronic device may be limited, and usually a few pop-up comment libraries corresponding to some image information may be stored. Based on this, the electronic device may determine whether the image information is preset or not, and if so, obtain the target pop-up comment from the pop-up comment library corresponding to the image information.

For example, the electronic device merely stores a pop-up comment library about food, and the electronic device may obtain a matching pop-up comment from a local pop-up comment library during a process of capturing food, and the electronic device may not obtain a matching pop-up comment from the local pop-up comment library during a process of capturing a landscape.

In the embodiment, the electronic device locally stores a pop-up comment library, and the electronic device obtains a pop-up comment from the local pop-up comment library, without interacting with the server, and independent from the network. Even if network connection is poor, the pop-up comment may still be obtained, and the pop-up comment may still be displayed.

In step 103, the image and the target pop-up comment are displayed.

In an embodiment, after obtaining the image and the target pop-up comment, the electronic device displays the image and the target pop-up comment on the screen, thereby realizing the pop-up comment effect, increasing the feeling of interest and interaction during the capturing process, and improving the capturing experience of the user.

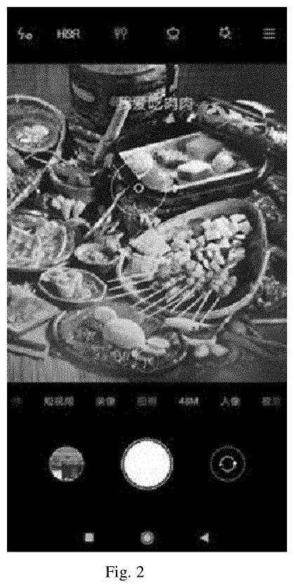

For example, FIG. 2 is an image displayed on a screen according to an exemplary embodiment. The image shown in FIG. 2 is a food image, and upon recognizing the content category information of the image as a food category, the electronic device obtains a pop-up comment, e.g., “I like eating meat” corresponding to the food category, and displays the pop-up comment “I like eating meat” on the image.

In an embodiment, the target pop-up comment may include comment information on content of the currently obtained image. For example, multiple information forms of the target pop-up comment may be provided, such as text, an emotion icon, a symbol, etc. The target pop-up comment may further include a display mode of the comment information, for example, a display time, a pop-up position in the image, a pop-up direction, a pop-up speed, and the like.

When the target pop-up comment includes only the comment information, the comment information may be displayed on the screen according to a preset display mode. When the target pop-up comment includes the comment information and the display mode of the comment information, the comment information may be displayed on the screen according to the display mode involved in the target pop-up comment.

In an embodiment, the electronic device may provide an editing entry for pop-up comment, such that the user may edit the pop-up comment in the local pop-up comment library, improving the use experience.

In an embodiment, multiple modes of displaying the image and the target pop-up comment may be provided. For example, in a first display mode, the target pop-up comment is displayed on an upper layer of the image; in a second display mode, the image and the target pop-up comment are displayed in a partitioned region; in a third display mode, in a case where the electronic device includes two or more screens, the image and the target pop-up comment are displayed in a split screen.

For the second display mode, for example, the screen includes a first display region and a second display region, and the image is displayed in the first display region and the target pop-up comment is displayed in the second display region.

For the third display mode, for example, the electronic device includes two screens, an image is displayed on one screen, and a target pop-up comment is displayed on the other screen.

In an embodiment, the electronic device may provide an editing entry of the display mode, such that the user may edit the display mode, thereby improving the use experience.

In an embodiment, the electronic device may generate and store a capturing file according to the image and the target pop-up comment. The capturing file may be displayed in a pop-up manner The capturing file may be a photo file and/or a video file.

In an embodiment, the capturing file may be generated based on the image and the target pop-up comment. For example, the target pop-up comment is written into an image file of the image, and a capturing file is generated. In this example, the image file is modified. In another example, the target pop-up comment is written into text, and the image file and the text of the image are combined, to generate a capturing file. In this example, the image file may carry the text.

For a photo in JPEG (Joint Photographic Experts Group) format, a length of the text carried with the target pop-up comment may be written into metadata described in xmp (eXtensible Metadata Platform) of the image file of the photo, and text data including the length of the text is added to the tail of the image file, thereby obtaining a photo file with a pop-up comment display.

When displaying a photo based on the photo file, after reading the metadata described in xmp, the electronic device reads length information in the metadata, and reads data of a corresponding length from the tail of the photo file, thereby obtaining a target pop-up comment, and displaying a pop-up comment based on the target pop-up comment.

An image file in HEIF (High Efficiency Image File) format supports the self-defined data as an independent data block. During the capturing process, the target pop-up comment may be written into the text, and the image file and the text in the HEIF format are combined, such that a photo file with a pop-up comment display is obtained.

For a video encapsulation format supporting an internal self-defined data structure, a captured video may be encapsulated into such format, the target pop-up comment may be written into text, and a video file and the text written with pop-up comment may be combined, to obtain a video file with a pop-up comment display.

For example, the mkv encapsulation format is supported in an internal self-defined data structure, such as a multi-track, a multi-caption, etc., and the text written with the target pop-up comment and a video file in the mkv format are combined.

A capturing file is generated by combining an image file and the text written with the pop-up comment, and the user may control the electronic device to turn on or turn off the pop-up comment display by triggering a preset option or key during the capturing process, and the image file is not affected.

In the above embodiments, the electronic device obtains an image captured during the capturing process, obtains a target pop-up comment matching the image information of the image, and displays the image and the target pop-up comment, thereby increasing the interestingness and interaction at the capturing stage, and improving the capturing experience of the user.

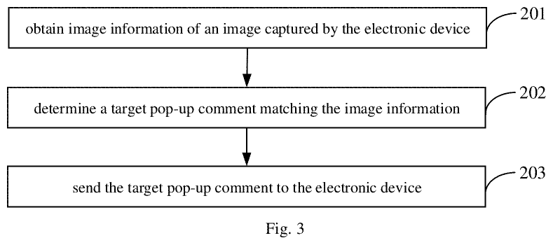

FIG. 3 is a flowchart of a capturing method according to an exemplary embodiment. The method shown in FIG. 3 is applicable to a server, and includes the following steps.

In step 201, image information of an image captured by an electronic device is obtained.

The image information may include at least one of: image data, capturing scene information, or image classification information. For example, multiple types of image data may be provided, and the image data may include at least one of: the image per se, the image color data, or the image brightness data, or the like. The capturing scene information may indicate a specific capturing scene of the image. The image classification information may indicate classification of the image. Also for example, multiple types of image classification information may be provided, such as scene type information, content category information, etc.

In an embodiment, the server may obtain the image information of the image captured by the electronic device using one of the following methods. In the first method: the server receives the image information from the electronic device. In the second method, the server receives an image captured and sent by the electronic device, and determines image information of the image.

For the first method, after the electronic device captures an image, the electronic device obtains image information of the image, and sends the image information to the server. Accordingly, the server obtains the image information directly from the electronic device. The image information may include at least one of: image per se, image color data, image brightness data, capturing scene information, scene type information, or content category information, or the like.

For the second method, after the electronic device collects an image, the electronic device sends the image to the server. Accordingly, the server determines the image information according to the image from the electronic device. The image information may include at least one of: image color data, image brightness data, capturing scene information, scene type information, or content category information, etc.

In step 202, a target pop-up comment matching the image information is determined.

In an embodiment, the server pre-establishes a first correspondence between image information and pop-up comments. When executing this step, the server determines the target pop-up comment corresponding to the current image information according to the first correspondence. For example, the server pre-establishes a correspondence between specified buildings and pop-up comments. When an image includes specified buildings, the server determines the pop-up comment corresponding to the specified buildings according to the correspondence between specified buildings and pop-up comments.

In the above embodiment, the server directly determines the target pop-up comment based on the image information. In an embodiment, the server pre-establishes a second correspondence between image information types and pop-up comments. When executing this step, the server determines the image information type corresponding to current image information, and determines the target pop-up comment corresponding to the image information type according to the pre-established second correspondence.

The image information type may indicate an information category of the image, for example, the image information type may include at least one of an image content type or an image scene type, where the image content type indicates a content category of the image, and the image scene type indicates a capturing scene category of the image. In an embodiment, the image information type may be set corresponding to the image classification information in the image information. For example, the classifying method of the image information type may be the same as the classifying method of the image classification information. Also for example, the classifying method of the image content type in the image information type may be the same as that of the content category information in the image classification information, and the classifying method of the image scene type in the image information type may be the same as that of the scene type information in the image classification information.

When the image information includes at least one of capturing scene information or scene type information, the image information type may include an image scene type. When the image information includes at least one of image data or content category information, the image information type may include an image content type.

For example, the server pre-establishes a correspondence between the food category and the pop-up comments. When the image involves the food, the server determines the food category corresponding to the food, and determines the pop-up comment corresponding to the food category according to the pre-established correspondence.

In the above embodiment, the server determines an image information type according to the image information, and determines a target pop-up comment according to the image information type.

In an embodiment, the server may establish a second correspondence between image information types and pop-up comments in the following manner

First, a target video is determined, where the target video includes pop-up comments.

The target video presents a pop-up comment when being played, and thus presents a pop-up comment effect. The target video may be a short video, a television, etc.

Some video websites may provide videos including pop-up comments, and a target video may be obtained from such websites.

Second, a target image frame set is obtained from the target video.

The server may determine image information of an image frame in the target video, further determine an image information type of the image frame, and collect the image frames with the same image information type to obtain a target image frame set.

In an embodiment, it is determined that the image information types of continuously played multi-frame images in the target video are the same, and a target image frame set is obtained based on the multi-frame images.

For example, the server determines whether the image information types of the continuously played multi-frame images within a preset duration are the same, and if so, the server obtains a target image frame set based on the continuously played multi-frame images within the preset duration.

For another example, the server determines that the image information types of the continuously played preset number of image frames are the same, and obtains a target image frame set based on the continuously played preset number of image frames.

In an embodiment, the target video is a food recording video, and the server obtains the image content type of the multi-frame images continuously played within a preset duration as the food category, and obtains the target image frame set based on the multi-frame images continuously played within the preset duration.

In an embodiment, images having the same image information type are acquired from a target video, and a target image frame set is obtained based on the images having the same image information type.

For example, images having the same image information type may be a continuous frame or a discontinuous frame.

After determining the image information type of the image frame in the target video, the server may provide a label for the image frame, where the label indicates the image information type, and the server may obtain a target image frame set having the same image information type from the target video by identifying the label.

Further, pop-up comments in the target image frame set are extracted.

The pop-up comments may include comment information, and may further include a display mode of the comment information. For example, multiple information forms of the comment information are provided, such as text, emoticon, symbol, etc. Also for example, multiple display modes of the comment information are provided, for example, display time, a pop-up position in the image, a pop-up direction, a pop-up speed, and the like.

The server may extract the comment information from the target image frame set, or may extract the comment information and the display mode thereof from the target image frame set.

Finally, a correspondence between image information types and pop-up comments in a target image frame set is established.

The above method may establish a correspondence between sets of image information types and pop-up comments.

The pop-up comments in the target image frame set may be placed in the target pop-up comment library by the server, where the target pop-up comment library is established for the image information type of the target image frame set. Through the above method, respective pop-up comment libraries may be established for different types of image information.

In step 203, the target pop-up comment is sent to the electronic device.

In embodiments of the present disclosure, the server obtains image information of an image captured by the electronic device, determines a target pop-up comment matching the image information, and sends the target pop-up comment to the electronic device, such that the electronic device displays the image and the target comment information on the screen, presenting a pop-up comment display effect, thereby increasing the interestingness and interaction at the capturing stage, and improving the user's capturing experience.

Those skilled in the art will understand that the present disclosure is not limited by the described order of steps. Some steps may be performed in another order or simultaneously. Some steps may not be needed.

Corresponding to the foregoing method embodiments, embodiments of an apparatus for performing the method, such as electronic device and server, are provided in the present disclosure.

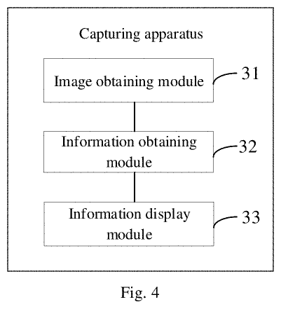

FIG. 4 is a block diagram of a capturing apparatus according to an exemplary embodiment. The apparatus is applicable to an electronic device, and includes: an image obtaining module 31, an information obtaining module 32, and an information display module 33.

The image obtaining module 31 is configured to obtain an image captured during a capturing process.

The information obtaining module 32 is configured to obtain a target pop-up comment matching the image information of the image.

The information display module 33 is configured to display the image and the target pop-up comment.

In an embodiment, the image information includes at least one of: image data, capturing scene information, or image classification information.

In an embodiment, the image information may include the image classification information, and the information obtaining module 32 may include one of: a first information determining sub-module and a second information sub-module.

The first information determining sub-module is configured to, in case where the image classification information includes content category information, determine the content category information of the image according to a content of the image.

The second information determining sub-module is configured to, in case where the image classification information includes scene classification information, determine the capturing scene information of the image according to the content of the image, and determine the scene classification information corresponding to the capturing scene information.

In an embodiment, the information obtaining module 32 may include any one of: a sending sub-module and an obtaining sub-module.

The sending sub-module is configured to send the image information to a server such that the server obtains the target pop-up comment matching the image information, and receive the target pop-up comment from the server.

The obtaining sub-module is configured to determine whether the image information conforms the preset image information, and if the image information conforms the preset image information, obtain the target pop-up comment from a pop-up comment library corresponding to the preset image information.

In an embodiment, the apparatus may further include a file generating module and a file storing module.

The file generation module is configured to generate a capturing file based on the image and the target pop-up comment.

The file storing module is configured to store the capturing file.

In an embodiment, the file generating module may include any one of an information writing sub-module and a text combining sub-module.

The information writing sub-module is configured to write the target pop-up comment into an image file of the image to generate the capturing file.

The text combining sub-module is configured to write the target pop-up comment into text, and combine the image file of the image and the text, to generate the capturing file.

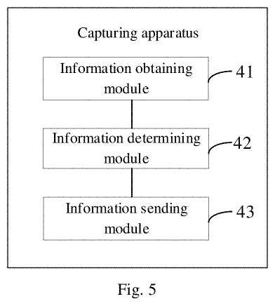

FIG. 5 is a block diagram of a capturing apparatus according to an exemplary embodiment. The apparatus is applicable to a server, and includes an information obtaining module 41, an information determining module 42, and an information sending module 43.

The information obtaining module 41 is configured to obtain image information of an image captured by the electronic device.

The information determining module 42 is configured to determine a target pop-up comment matching the image information.

The information sending module 43 is configured to send the target pop-up comment to the electronic device.

In an embodiment, the information obtaining module 41 may include any one of an information receiving sub-module and an information determining sub-module.

The information receiving sub-module is configured to receive the image information from the electronic device.

The information determining sub-module is configured to receive the image captured from the electronic device, and determine the image information of the image.

In an embodiment, the information determining module 42 may include any one of: a first pop-up comment determining sub-module and a second pop-up comment determining sub-module.

The first pop-up comment determining sub-module is configured to determine the target pop-up comment corresponding to the image information according to a pre-established first correspondence between image information and pop-up comments.

The second pop-up comment determining sub-module is configured to determine image information type corresponding to the image information, and determine the target pop-up comment corresponding to the image information type according to a pre-established second correspondence between the image information types and the pop-up comments.

In an embodiment, the apparatus may further include a video determination module, a set obtaining module, an information extracting module, and a relationship establishment module.

The video determination module is configured to determine a target video, where the target video includes pop-up comment.

The set obtaining module is configured to obtain a target image frame set from the target video.

The information extracting module is configured to extract the pop-up comment from the target image frame set.

The relationship establishing module is configured to establish the second correspondence between the image information types and the pop-up comments of the target image frame set.

In an embodiment, the set obtaining module may include any one of a first set obtaining sub-module and a second set obtaining sub-module.

The first set obtaining sub-module is configured to determine that image information types of multiple frames of images continuously played in the target video are the same, and obtain the target image frame set based on the multiple frames of images.

The second set obtaining sub-module is configured to obtain images with the same image information type from the target video, and obtain the target image frame set based on the images with the same image information type.

The apparatus embodiments substantially correspond to the method embodiments and, for operations by each module, reference may be made to the description of the method embodiments. The apparatus embodiments are merely exemplary, in which the modules described as separate components may or may not be physically separated, and the components displayed as modules may or may not be physical units, may be located in one place, or may be distributed to a plurality of network units. Some or all of the modules may be selected according to actual needs.

Embodiments of the present disclosure also provide an electronic device, which includes a screen, a camera, a processor and a memory for storing instructions executed by the processor. By executing the instructions corresponding to a control logic for capturing, the processor is configured to: obtain an image captured during a capturing process; obtain a target pop-up comment matching image information of the image; and display the image and the target pop-up comment.

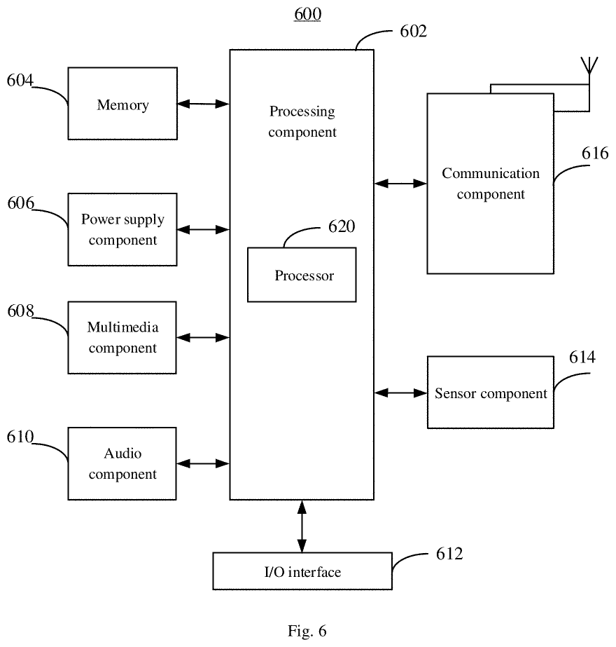

FIG. 6 is a schematic diagram of an electronic device 600 according to an exemplary example. For example, the electronic device 600 may be a client device, and may specifically be a mobile phone, a computer, a digital broadcasting terminal, a message receiving and transmitting device, a game console, a tablet device, a medical device, a fitness device, a personal digital assistant, an internet of things device, a wearable device such as a smart watch, a smart glass, a smart band, a smart running shoe, and so on.

Referring to FIG. 6, the electronic device 600 may include one or more of the following components: a processing component 602, a memory 604, a power component 606, a multimedia component 608, an audio component 610, an input/output (I/O) interface 612, a sensor component 614, and a communication component 616.

The processing component 602 generally controls overall operations of the electronic device 600, such as operations associated with display, phone calls, data communications, camera operations, and recording operations. The processing component 602 may include one or more processors 620 to execute instructions to complete all or part of the steps of the above methods. In addition, the processing component 602 may include one or more modules which facilitate the interaction between the processing component 602 and other components. For example, the processing component 602 may include a multimedia module to facilitate the interaction between the multimedia component 608 and the processing component 602.

The memory 604 is to store various types of data to support the operation of the electronic device 600. Examples of such data include instructions for any application or method operated on the electronic device 600, contact data, phonebook data, messages, pictures, videos, and so on. The memory 604 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power supply component 606 provides power to different components of the electronic device 600. The power supply component 606 may include a power management system, one or more power supplies, and other components associated with generating, managing, and distributing power for the electronic device 600.

The multimedia component 608 includes a screen providing an output interface between the electronic device 600 and a user. In some examples, the screen may include a Liquid Crystal Display (LCD) and a Touch Panel (TP). If the screen includes the TP, the screen may be implemented as a touch screen to receive input signals from the user. The TP may include one or more touch sensors to sense touches, swipes, and gestures on the TP. The touch sensors may not only sense a boundary of a touch or swipe, but also sense a duration and a pressure associated with the touch or swipe. In some examples, the multimedia component 608 may include a front camera and/or a rear camera. The front camera and/or rear camera may receive external multimedia data when the electronic device 600 is in an operating mode, such as a capturing mode or a video mode. Each of the front camera and the rear camera may be a fixed optical lens system or have focal length and optical zooming capability.

The audio component 610 is configured to output and/or input an audio signal. For example, the audio component 610 includes a microphone (MIC). When the electronic device 600 is in an operating mode, such as a call mode, a recording mode, and a voice recognition mode, the MIC is to receive an external audio signal. The received audio signal may be further stored in the memory 604 or sent via the communication component 616. In some examples, the audio component 610 further includes a speaker to output an audio signal.

The I/O interface 612 may provide an interface between the processing component 602 and peripheral interface modules. The above peripheral interface modules may include a keyboard, a click wheel, buttons and so on. These buttons may include, but are not limited to, a home button, a volume button, a starting button and a locking button.

The sensor component 614 includes one or more sensors to provide status assessments of various aspects for the electronic device 600. For example, the sensor component 614 may detect the on/off status of the electronic device 600, and relative positioning of component, for example, the component is a display and a keypad of the electronic device 600. The sensor component 614 may also detect a change in position of the electronic device 600 or a component of the electronic device 600, a presence or absence of the contact between a user and the electronic device 600, an orientation or an acceleration/deceleration of the electronic device 600, and a change in temperature of the electronic device 600. The sensor component 614 may include a proximity sensor to detect the presence of a nearby object without any physical contact. The sensor component 614 may further include an optical sensor, such as a Complementary Metal-Oxide-Semiconductor (CMOS) or Charged Coupled Device (CCD) image sensor which is used in imaging applications. In some examples, the sensor component 614 may further include an acceleration sensor, a gyroscope sensor, a magnetic sensor, a pressure sensor, or a temperature sensor.

The communication component 616 is to facilitate wired or wireless communication between the electronic device 600 and other devices. The electronic device 600 may access a wireless network that is based on a communication standard, such as Wi-Fi, 4G or 5G, or a combination thereof. In an embodiment, the communication component 616 receives a broadcast signal or broadcast-associated information from an external broadcast management system via a broadcast channel. In an embodiment, the communication component 616 further includes a Near Field Communication (NFC) module to facilitate short-range communications. In an embodiment, the communication component 616 may be implemented based on a Radio Frequency Identification (RFID) technology, an Infrared Data Association (IrDA) technology, an Ultra Wideband (UWB) technology, a Bluetooth® (BT) technology and other technologies.

In an embodiment, the electronic device 600 may be implemented by one or more Application Specific Integrated Circuits (ASIC), Digital Signal Processors (DSP), Digital Signal Processing Devices (DSPD), programmable Logic Devices (PLD), Field Programmable Gate Arrays (FPGA), controllers, microcontrollers, microprocessors, or other electronic components for performing the above methods.

In an embodiment, a non-transitory computer-readable storage medium including instructions is provided, such as the memory 604 including instructions. The instructions may be executed by the processor 620 of the electronic device 600 to perform the above described capturing method including: obtaining an image captured during capturing process, obtaining a target pop-up comment matching image information of the image, and displaying the image and the target pop-up comment. The non-transitory computer-readable storage medium may be a Read-Only Memory (ROM), a Random Access Memory (RAM), a Compact disc ROM (CD-ROM), a magnetic tape, a floppy disk, and an optical data storage device and so on.

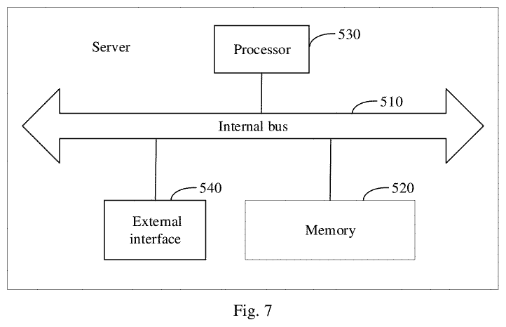

Embodiments of the present disclosure also provide a server. FIG. 7 is a schematic diagram of the server according to an exemplary embodiment. The server may include: a memory 520, a processor 530, and an external interface 540 connected through an internal bus 510.

The external interface 540 is configured to obtain data.

The memory 520 is configured to store machine-readable instructions corresponding to capturing.

The processor 530 is configured to read the machine-readable instructions on the memory 520 and execute the instructions corresponding to a control logic for capturing to implement the following operations: obtaining image information of an image captured by the electronic device; determining a target pop-up comment matching the image information; and sending the target pop-up comment to the electronic device.

In an embodiment, a non-transitory computer-readable storage medium including instructions is provided, such as the memory 520 including instructions. The instructions may be executed by the processor 530 of the server to perform the above described capturing method. The non-transitory computer-readable storage medium may be a Read-Only Memory (ROM), a Random Access Memory (RAM), a Compact disc ROM (CD-ROM), a magnetic tape, a floppy disk, and an optical data storage device and so on.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the appended claims.

It is to be understood that the present disclosure is not limited to the precise structure described above and shown in the accompanying drawings, and that various modifications and changes may be made without departing from the scope thereof. The scope of the present disclosure is limited only by the appended claims.

What is claimed is:

1. A capturing method for an electronic device, comprising:
obtaining an image captured during a capturing process;
obtaining a target pop-up comment matching image information of the image; and
displaying the image and the target pop-up comment.

2. The method according to claim 1, wherein the image information comprises at least one of: image data, capturing scene information, or image classification information.

3. The method according to claim 2, further comprising:
determining content category information of the image according to a content of the image.

4. The method according to claim 2, further comprising:
determining capturing scene information of the image according to the content of the image, and determining scene classification information corresponding to the capturing scene information.

5. The method according to claim 1, wherein obtaining the target pop-up comment matching the image information of the image comprises:
sending the image information to a server, such that the server obtains the target pop-up comment matching the image information; and
receiving the target pop-up comment from the server.

6. The method according to claim 1, wherein obtaining the target pop-up comment matching the image information of the image comprises:
determining whether the image information conforms preset image information; and
in response to the image information conforming the preset image information, obtaining the target pop-up comment from a pop-up comment library corresponding to the preset image information.

7. The method according to claim 1, further comprising:
generating a capturing file based on the image and the target pop-up comment; and
storing the capturing file.

8. The method according to claim 7, wherein generating the capturing file based on the image and the target pop-up comment comprises:
writing the target pop-up comment into an image file of the image to generate the capturing file.

9. The method according to claim 7, wherein generating the capturing file based on the image and the target pop-up comment comprises:
writing the target pop-up comment into text, and combining an image file of the image and the text to generate the capturing file.

10. A capturing method for a server, comprising:
obtaining image information of an image captured by an electronic device;
determining a target pop-up comment matching the image information; and
sending the target pop-up comment to the electronic device.

11. The method according to claim 10, wherein obtaining the image information of the image captured by the electronic device comprises one of:
receiving the image information from the electronic device; or
receiving the image captured from the electronic device, and determining the image information of the image.

12. The method according to claim 10, wherein determining the target pop-up comment matching the image information comprises:
determining the target pop-up comment corresponding to the image information according to a pre-established correspondence between image information and pop-up comments.

13. The method according to claim 10, wherein determining the target pop-up comment matching the image information comprises:
determining image information type corresponding to the image information; and
determining the target pop-up comment corresponding to the image information type according to a pre-established correspondence between image information types and pop-up comments.

14. The method according to claim 13, further comprising:
determining a target video, wherein the target video comprises pop-up comments;
obtaining a target image frame set from the target video;
extracting the pop-up comments from the target image frame set; and
establishing the correspondence between the image information types and the pop-up comments of the target image frame set.

15. The method according to claim 14, wherein obtaining the target image frame set from the target video comprises:
determining that image information types of multiple frames of images continuously played in the target video are same, and obtaining the target image frame set based on the multiple frames of images.

16. The method according to claim 14, wherein obtaining the target image frame set from the target video comprises:
obtaining images with a same image information type from the target video, and obtaining the target image frame set based on the images with the same image information type.

17. An electronic device, comprising:
a processor; and
a memory storing instructions executable by the processor,
wherein the processor is configured to;
obtain an image captured during a capturing process;
obtain a target pop-up comment matching the image information of the image; and
display the image and the target pop-up comment.

18. A server, comprising:
a processor; and
a memory storing instructions executable by the processor,
wherein the processor is configured to perform the method according to claim 10.

19. A non-transitory computer-readable storage medium having stored thereon instructions that, when executed by a processor of an electronic device, cause the electronic device to perform the method according to claim 1.

20. A non-transitory computer-readable storage medium having stored thereon instructions that, when executed by a processor of a server, cause the server to perform the method according to claim 10.
